(19) United States
(12) Patent Application Publication
(10) Pub. No.: US 2025/0325422 A1
(43) Pub. Date: Oct. 23, 2025

(54) PATIENT TURNING APPARATUS

(71) Applicant: Frontier Therapeutics Limited, Tredegar (GB)

(72) Inventors: Jon Morse, Caerphilly (GB); Simon Bosley, Cardiff (GB)

(21) Appl. No.: 18/870,492

(22) PCT Filed: Feb. 28, 2023
(86) PCT No.: PCT/GB2023/050450

§ 371 Date: Nov. 29, 2024

(30) Foreign Application Priority Data
May 30, 2022 (GB) 2207967.7

(51) Int. Cl. A61G 7/00; A61G 7/057

(52) U.S. Cl. CPC A61G 7/001; A61G 7/05769

(57) ABSTRACT

A patient turning apparatus comprising a reconfigurable support platform comprising a longitudinally extending central region, and a first lateral side disposed at a first side of the central region and a second lateral side disposed at a second side of the central region. The platform further comprises a first primary bladder arrangement and a first secondary bladder arrangement disposed at the first lateral side and configured to impart a tilt to the first side of the platform about the central region. The platform further comprise a second primary bladder arrangement and a second secondary bladder arrangement disposed at the second lateral side and configured to impart a tilt to the second side of the platform about the central region. The support platform further comprises a first and second conduit along which a fluid is arranged to pass.

### CROSS-REFERENCE TO RELATED APPLICATIONS

The present application is the U.S. National Stage Application pursuant to 35 U.S.C. § 371 of International Patent Application No. PCT/GB2023/050450, filed on Feb. 28, 2023, which application claims priority to United Kingdom Patent Application No. 2207967.7, filed on May 30, 2022, which applications are hereby incorporated by reference herein in their entireties.

### FIELD

The present invention relates to a patient turning apparatus.

### BACKGROUND

Individuals who are unable to move autonomously and who are thus restricted to a particular position, such as a recumbent position when lying on a bed, are prone to developing pressure sores. To minimise the development of these sores, it is necessary to reposition the individual upon the bed at regular intervals. However, this is often difficult for a single carer and often requires several carers to suitably reposition the individual. Moreover, given that those individuals who are susceptible to developing pressure sores require repositioning at regular intervals, typically every 2 hours, then it is evident that this is a time intensive process.

GB2449318 discloses an automatic patient turning apparatus having a support platform comprising support sections, which can pivot about a central longitudinal region of the platform to turn a patient lying thereon onto their left or right side. The disclosed apparatus comprises two support sections disposed at each side of the central region which are uncoupled, so that the sections on the same side can pivot independently of each other. The uncoupled nature of the two sections at each side of the central region enables the platform to pivot as the configuration of the underlying bed changes. However, the skilled reader will recognise that the positioning of the separation between sections must match the location of the hinge coupling between sections of the underlying bed frame to enable the pivotal movement of the platform. In this respect, a two-section support platform is required for a bed frame having two sections which are hingedly coupled. Similarly, a three-section support platform would be required for a bed frame having three sections. It is evident therefore that the apparatus is restricted to the particular bed frame. Moreover, it is desirable for sections of a bed frame to move through auto-regression, whereby the location of the hinge coupling between sections of the bed frame move along the bed to follow the natural movement of a patient's legs and waist flexion, for example.

WO2019/081954 discloses a patient turning apparatus comprising a plurality of support slats which are arranged to extend laterally across a mattress from a central longitudinal region. The apparatus further comprises a plurality of inflatable chambers disposed between the slats and base of the apparatus for pivoting the slats relative to the mattress to turn a patient. However, when inflating the chambers to pivot the slats it is found that patients can migrate or slide down from the tilted side toward the non-tilted side. This can lead to a patient moving across a mattress from one side to the other, without being subject to any turning. This can lead to a patient being pressed up against bed rails and/or becoming entangled with the bed rails.

### SUMMARY

We have now devised an improved patient turning apparatus.

In accordance with an aspect of the present invention there is provided patient turning apparatus comprising: a reconfigurable support platform comprising: a longitudinally extending central region; a first lateral side disposed at a first side of the central region and a second lateral side disposed at a second side of the central region; a first primary bladder arrangement and a first secondary bladder arrangement disposed at the first lateral side, and configured to impart a tilt to the first side of the platform about the central region; a second primary bladder arrangement and a second secondary bladder arrangement disposed at the second lateral side, and configured to impart a tilt to the second side of the platform about the central region; the first primary bladder arrangement and second secondary bladder arrangement forming a first patient turning arrangement, the second primary bladder arrangement and first secondary bladder arrangement forming a second patient turning arrangement, the support platform further comprising: a first and second conduit along which a fluid is arranged to pass, the first conduit being fluidly coupled to the bladder arrangements of first patient turning arrangement for simultaneously conveying fluid to and from the bladder arrangement of the first patient turning arrangement, the second conduit being fluidly coupled to the bladder arrangements of the second patient turning arrangement for simultaneously conveying fluid to and from the bladder arrangement of the second patient turning arrangement.

In an embodiment, the first primary bladder arrangement and first secondary bladder arrangement are disposed in a stacked configuration, whereby in use, the first primary bladder arrangement is disposed upon the first secondary bladder arrangement, for example. Similarly, the second primary bladder arrangement and the second secondary bladder arrangement are disposed in a stacked configuration, whereby in use, the second primary bladder arrangement is disposed upon the second secondary bladder arrangement for example.

In an embodiment, the primary bladder arrangement of each patient turning arrangement is configured to tilt the respective lateral side of the platform through an angular range greater than that of the secondary bladder arrangement of the same patient turning arrangement, and typically comprises 20⁰-30⁰. The secondary bladder arrangement of each patient turning arrangement is configured to tilt the respective lateral side of the platform through an angular range of 3⁰-10⁰. The secondary bladder arrangement is arranged to cooperate with the primary bladder arrangement at the opposite side of the central region to form a cradle to support the patient during the turning procedure. The inclination created by the secondary bladder arrangement is arranged to support the patient to prevent an over-rotation of the patient.

In an embodiment, the apparatus further comprises a plurality of support slats configured for pivotal movement about the central region, the support slats being configured in use to extend over the first and second primary bladder arrangements. The support slats extend in a substantially parallel configuration when configured in an un-pivoted configuration, and are longitudinally separated along the platform.

In an embodiment, the plurality of laterally extending support slats comprise a first plurality of laterally extending support slats which extend to the first side of the central region and a second plurality of laterally extending support slats which extend to the second side of the central region. The first and second plurality of support slats extend in substantially the same plane when configured in an un-pivoted configuration.

In an embodiment, the first conduit comprises a first primary sub-conduit which is fluidly coupled to the first primary bladder arrangement and a first secondary sub-conduit which is fluidly coupled to the second secondary bladder arrangement. A distal end of the first primary sub-conduit extends a first distance from a first lateral side edge of the platform and a distal end of the first secondary sub-conduit extends a second distance from a second lateral side edge of the platform, the first and second distances permitting a fluid coupling of the distal end of the first primary sub-conduit with the distal end of the first secondary sub-conduit. In addition, a section of the first primary and first secondary sub-conduits, namely a section disposed intermediate a respective proximal and distal end thereof, comprises a plurality of perforations disposed along a length thereof for fluidly coupling with the first primary bladder and second secondary bladder arrangement, respectively.

In an embodiment, the second conduit similarly comprises a second primary sub-conduit which is fluidly coupled to the second primary bladder arrangement and a second secondary sub-conduit which is fluidly coupled to the first secondary bladder arrangement. A distal end of the second primary sub-conduit extends a first distance from a second lateral side edge of the platform, a distal end of the second secondary sub-conduit extends a second distance from a first lateral side edge of the platform, the first and second distances permitting a fluid coupling of the distal end of the second primary sub-conduit with the distal end of the second secondary sub-conduit. Also, a section of the second primary and second secondary sub-conduits, namely a section disposed intermediate a respective proximal and distal end thereof, comprises a plurality of perforations disposed along a length thereof for fluidly coupling with the second primary bladder and first secondary bladder arrangement, respectively.

In an embodiment, the apparatus further comprises a pump which is fluidly coupled to the first and second conduits, via a respective connector, for inflating and deflating the bladder arrangements of the first and second patient turning arrangements.

In an embodiment, the apparatus further comprises a removable cover which is arranged to enclose the first and second patient turning arrangements.

In an embodiment, the removable cover is further arranged to enclose the first and second, primary and secondary sub-conduits. The removable cover is further arranged to enclose the connectors disposed between the pump and the first and second conduits.

In an embodiment, the apparatus further comprises a control unit for controlling operation of the pump to control a selected inflation and deflation of the bladders associated with the first and second patient turning arrangements. The control unit further comprises a timer or clock for inflating and deflating the inflatable bladder at pre-selected times.

In an embodiment, each bladder arrangement of the first and second patient turning arrangements comprises a plurality of interconnected bladder elements, each element being detachably coupled at a proximal end thereof to the central region. The first primary bladder arrangement and second primary bladder arrangement separately comprise a two-tier arrangement of bladder elements with one tier being disposed above the other tier. However, the first secondary bladder arrangement and second secondary bladder arrangement comprise only a single tier of bladder elements.

In an embodiment, the bladder elements comprise a substantially triangular shape, whereby sides of each element converge from a distal end to the proximal end thereof.

In an embodiment, the first primary bladder arrangement and first secondary bladder arrangement are coupled together, such as via a weld, to prevent the first primary bladder arrangement and first secondary bladder arrangement from slipping relative to each other. Moreover, the bladder elements of the first primary bladder arrangement and first secondary bladder arrangement are coupled together. Separately, the second primary bladder arrangement and second secondary bladder arrangement are coupled together, such as via a weld, to prevent the second primary bladder arrangement and second secondary bladder arrangement from slipping relative to each other. In an embodiment, the bladder elements of the second primary bladder arrangement and second secondary bladder arrangement are coupled together, such as via a weld.

In an embodiment, each of the first plurality of support slats are configured to extend adjacent a corresponding bladder element of the first primary bladder arrangement and coupled thereto to prevent any slipping between the slat and the respective bladder element. Similarly, each of the second plurality of support slats are configured to extend adjacent a corresponding bladder element of the second primary bladder arrangement and coupled thereto to prevent any slipping between the slat and the respective bladder element.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

### BRIEF DESCRIPTION OF THE DRAWINGS

The invention may be performed in various ways and by way of example only, embodiments thereof will now be described, with reference being made to the accompanying drawings in which:

FIG. 1 is a perspective view of a patient turning apparatus according to an embodiment of the present invention, disposed upon a bed frame configured in a flattened configuration;

FIG. 2 is a perspective view of the patient turning apparatus illustrated in FIG. 1, disposed upon a bed frame configured in a profiled configuration;

FIG. 3 is a perspective view of the patient turning apparatus illustrated in FIG. 1, disposed upon a bed frame configured in a profiled configuration, with the second lateral side pivoted about the central region;

FIG. 4 is a perspective view of the patient turning apparatus according to a second embodiment of the present invention disposed upon a bed frame configured in a flattened configuration;

FIG. 5 is a schematic cross-section of the apparatus illustrated in FIG. 4, with (a) the apparatus configured in a first patient turning configuration and with (b) the apparatus configured in a second patient turning configuration;

FIG. 6 is a schematic plan view of a portion of a tier of bladder elements, showing the location of the weld to a neighbouring tier;

FIG. 7 is a schematic plan view of the apparatus shown in FIG. 4 with the first and second conduits configured in a first configuration; and,

FIG. 8 is a schematic perspective view of the apparatus shown in FIG. 4 with the first and second conduits configured in a second configuration.

### DETAILED DESCRIPTION

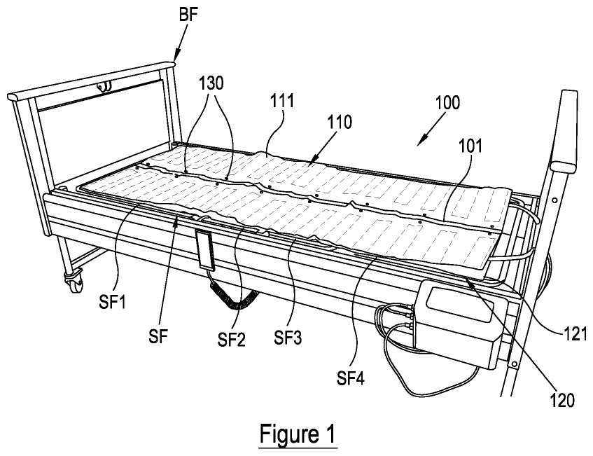

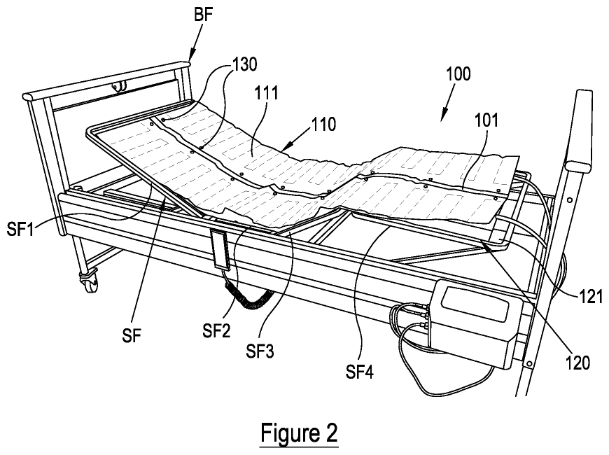

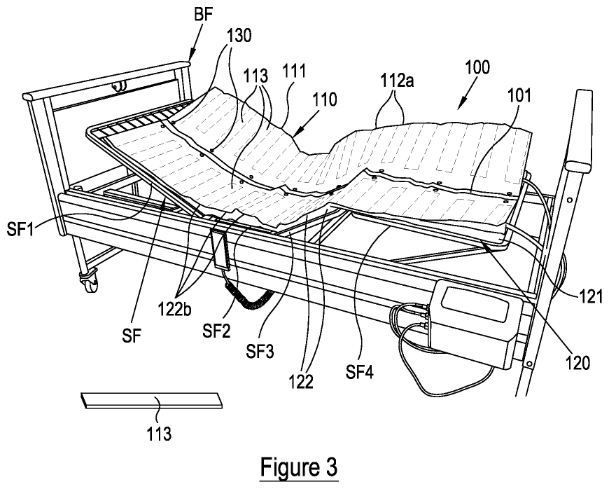

Referring to FIGS. 1 to 3 of the drawings, there is illustrated a patient turning apparatus 100 according to an embodiment of the present invention, disposed upon a bed frame BF which is arranged in a flattened configuration or profile. The bed frame comprises a support frame SF upon which the apparatus is disposed and in the illustrated embodiment, the support frame comprises four frame sections SF1-SF4 which are hingedly coupled along a lateral direction and which are arranged to provide support to different regions of a patient (not shown), such as the patient's upper body, waist region and lower body. The frame sections SF1-SF4 are arranged to pivot with respect to each other about the respective coupling (not shown) to reconfigure a longitudinal profile of the support frame. The frame sections SF1-SF4 are moved relative to each other about the respective hinge couplings (not shown) using a driving mechanism (not shown) which may be controlled via a controller. The driving mechanism may comprise a hydraulic, pneumatic, or electric mechanism for example, and is arranged to suitably configure the support frame to a preferred profile, such as that illustrated in FIG. 2 of the drawings, to suit the patient.

The apparatus 100 comprises a reconfigurable support platform 110 which in use is arranged uppermost on the support frame SF of the bed frame BF, and arranged to extend adjacent a mattress (not shown), for example. The support platform 110 comprises a flexible support sheet 111 which may be formed of a plastics material, such as polyurethane, or a fabric material, such as Nylon®, for example, which is detachably couplable with a base 120 via fasteners 130 disposed along a central longitudinal region 101. The support sheet 111 comprises a plurality of elongate pockets 112 formed therein which are orientated to extend laterally across the sheet, in a substantially parallel configuration. The pockets 112 are configured to a first plurality of pockets 112a which extend to a first side of the central longitudinal region 101 of the sheet and a second plurality of pockets 112b which extend to a second side of the central longitudinal region 101.

The pockets 112 are arranged to separately receive a support slat 113 having a substantially planar, elongate shape. The support slats 113 are formed of a rigid, plastics material, such as high-density polyethylene, and are arranged to provide a structural frame to the support sheet 111. The support slats 113 are longitudinally separated along the platform 100; however, owing to the slats 113 being disposed within the pockets 112, and the interconnection between pockets 112, by the support sheet 111, it is evident that any pivotal movement of one slat 113 will cause longitudinally adjacent slats 113 in adjacent pockets 112 to follow the pivotal movement. For example, as one slat 113 is pivoted upwardly about the central region 101, the portion of the sheet 111 disposed between the pocket 112 holding the one slat and adjacent pockets 112 will cause the slats in the adjacent pockets to also pivot.

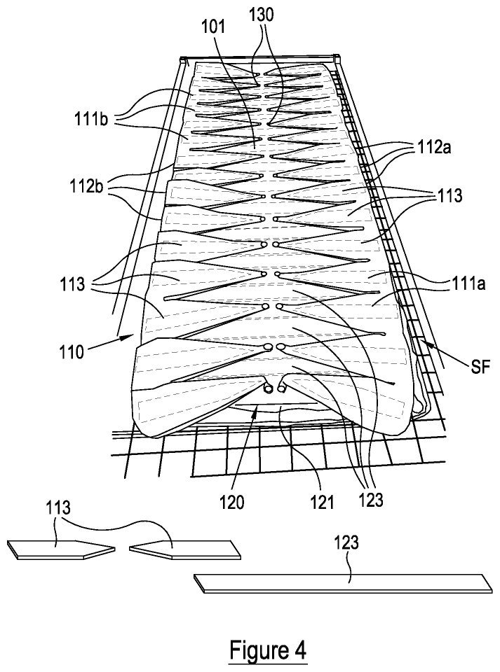

In a further embodiment, as illustrated in FIG. 4 of the drawings, the support sheet 111 may comprise a first array of triangular elements 111a disposed along the first side of the central longitudinal region 130 and a second array of triangular elements 111b disposed along the second side of the central longitudinal region 101. The triangular elements separately comprise a pocket 112 for receiving a support slat 113 and are detachably coupled at a proximal end thereof to the central region 101 via a respective fastener 130.

The central region 101 of the support platform 110 comprises a width such that a patient lying on the central region 101 extends over at least some of the support slats 113 disposed along the first and second side (namely right and left side) of the platform 110. In this respect, as the first/second plurality of support slats 113 pivot about the central region 101 a patient lying upon the platform 110 will be caused to turn to their left/right side, respectively.

The base 120 of the apparatus 100, which in use is arranged lowermost on the support frame SF of the bed frame BF and arranged to extend adjacent the support frame SF. The base 120 similarly comprises a flexible base sheet 121, which may be formed of a plastics material, as polyurethane, or a fabric material, such as Nylon®, for example. The base sheet 121 comprises a plurality of elongate pockets 122 formed therein which are orientated to extend laterally across the sheet, in a substantially parallel configuration. The pockets 122 are separately arranged to receive a base slat 123 (shown in FIG. 4) having a substantially planar, elongate shape. The base slats 123 are similarly formed of a rigid, plastics material, such as high-density polyethylene, and are arranged to provide a structural frame to the base sheet 121.

In an embodiment, the pockets 122 extend across the full width of the base sheet 123, either side of a central region 101. The rigid nature of the base slats 123 provides a lateral stiffness and lateral rigidity to the base which resists any flexing of the base along the width thereof. However, the disposition of the base slats 123 within the separated pockets 122 of the flexible base sheet permits the base to reconfigure along the length thereof to accommodate any variation or profile of the underlying support frame SF.

In an alternative embodiment which is not illustrated, the pockets 122 of the base 120 are configured to a first plurality of pockets (not shown) which extend to a first side of the central longitudinal region 101 and a second plurality of pockets (not shown) which extend to a second side of the central longitudinal region 101. In this respect, the first plurality of pockets are arranged to receive a first plurality of base slats (not shown) and the second plurality of pockets are arranged to receive a second plurality of base slats (not shown). The first and second plurality of base slats are separately configured to provide a lateral rigidity to the base 120 at the first and second side of the central region 101 of the base 120, while enabling the base 120 to articulate about the central region 101 to match any lateral undulation of the support frame SF. It is envisaged that this separation of the base slats 123 into a first and second group will provide for an additional flexibility to the apparatus 100 to accommodate a further variety of bed support frames.

In either embodiment of the base, the longitudinal separation of the base slats 123 enables the base to conform to a longitudinally undulating bed support frame SF and moreover, adopt the profile of the bed support frame SF. In this respect, it is evident that the base can follow the profile or contour of a multi-section bed frame and is not restricted for use with a three or four section profiling bed frame, for example.

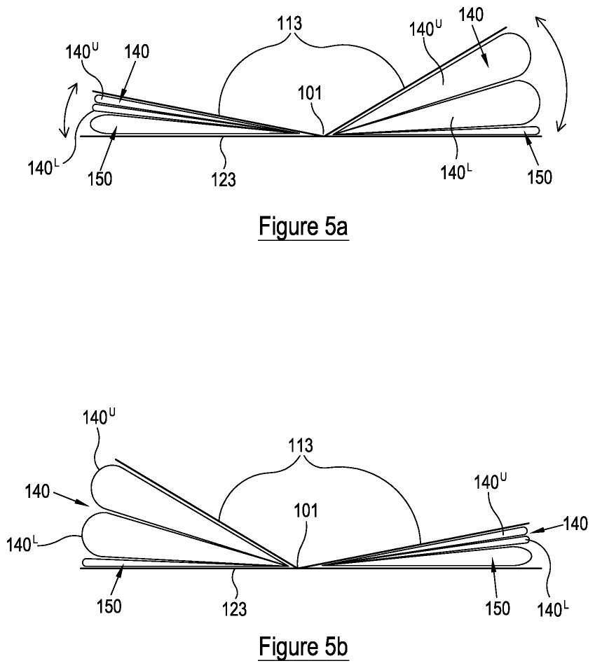

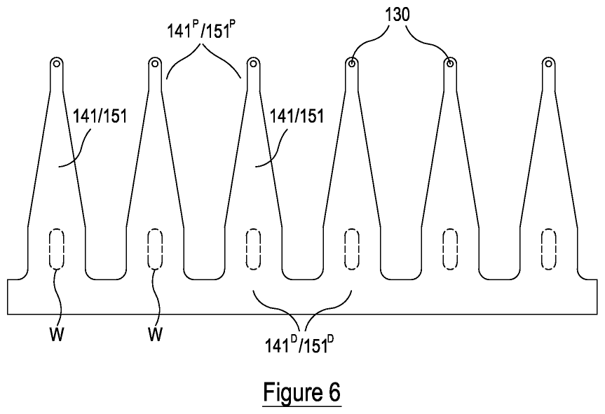

Referring to FIG. 5 of the drawings, the apparatus 100 further comprises a primary and secondary bladder arrangement 140, 150 disposed at each lateral side of the central region 101, which extends along the length of the platform 110. The primary bladder arrangement 140 comprises a linear array of bladder elements 141 (as shown in FIGS. 6-8), each of which comprises a generally triangular shape. The elements 141 are configured in a side-by-side arrangement and are fluidly coupled at their distal end 141D. The side walls of each element converge to a proximal end 141P of each element, and the proximal end of each bladder element 141 is detachably coupled to the central region 101 using a fastener 130. The primary bladder arrangement 140 comprises two arrays of bladder elements arranged in a lower and upper tier 140^{U}, 140^{L}, with the elements of the upper tier 140^{U} being arranged in fluid communication with the elements of the lower tier 140^{L}. In addition, the elements 141 of the upper tier 140^{U} are positioned upon and adjacent a corresponding element 141 from the lower tier 140^{L}, with adjacent elements being coupled together, such as via an ultrasonic weld W, to maintain a relative positioning of the elements 141 associated with the upper and lower tiers 140^{U}, 140^{L}.

The secondary bladder arrangement 150 which is disposed in use below the primary bladder arrangement 140 similarly comprises a linear array of bladder elements 151, each of which comprises a generally triangular shape. The elements 151 are configured in a side-by-side arrangement and are fluidly coupled at their distal end 151^{D}. The side walls of each element converge to a proximal end 151^{P} of each element, and the proximal end 151^{P} of each bladder element 151 is detachably coupled to the central region 101 using a fastener 130.

An upper side of each bladder element 141 of the upper tier 140^{U} of the primary bladder arrangement 140 is coupled with an underside of the support sheet 111, such as via an ultrasonic weld W, so that each support slat 113 is arranged to extend adjacent a corresponding bladder element 141 of the upper tier 140^{U}. The coupling maintains a relative positioning of the support slats 113 over the bladder elements 141 of the primary bladder arrangement 140 (and also the bladder elements 151 of the underlying secondary bladder arrangement 150) so that the slats 113 pivot in accordance with the inflation and deflation of the primary and secondary bladder arrangements 140, 150.

The bladder elements 141 associated with the lower tier 140^{L} of the primary bladder arrangement 140 are positioned upon and adjacent a corresponding element 151 from the secondary bladder arrangement 150. Moreover, adjacent elements are further coupled together, such as via an ultrasonic weld, to maintain a relative positioning of the elements 151 of the secondary bladder arrangement 150 with the elements 141 of the primary bladder arrangement 140. However, the primary and secondary bladder arrangements 140, 150 at one side of the platform are fluidly isolated from each other.

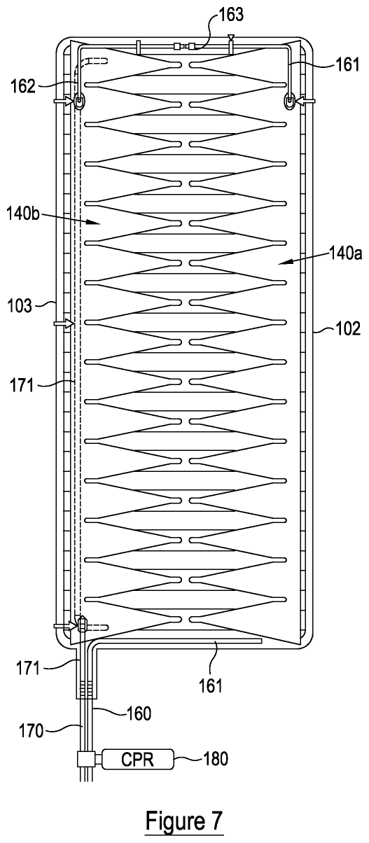

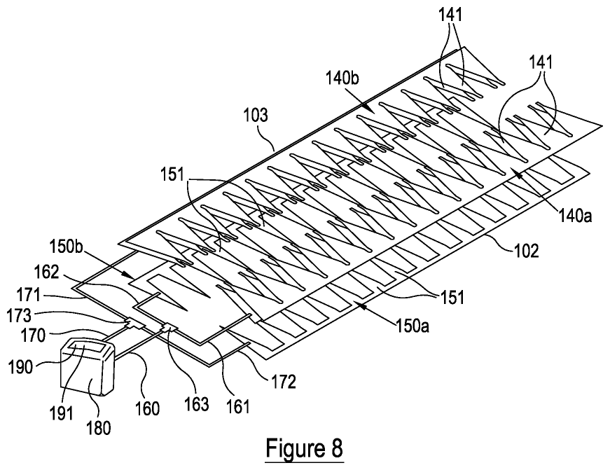

In a first fluid coupling embodiment, as illustrated in FIG. 7 of the drawings, the primary bladder arrangement 140 disposed at the first side of the central region 101, namely a first primary bladder arrangement 140a and the secondary bladder arrangement 150 disposed at the second side of the central region 101, namely a second secondary bladder arrangement 150b (shown in FIG. 8) are fluidly coupled together via a first conduit 160. The first conduit 160 comprises a primary 161 and secondary sub-conduit 162 which are coupled together at a connector 163, and the first conduit 160 is arranged to communicate a fluid between a pump 180 and the associated bladder arrangements 140, 150. The pump 180 is operated by a controller 190 (as shown in FIG. 8), which comprises a clock or timer (not shown) which enables an operator (not shown) to select a timing sequence for inflating and deflating the bladder arrangements 140, 150. For example, the controller 190 may include a control panel 191 having a user interface comprising a plurality of buttons (not shown) for selecting a 1-hour, 2-hour, 4-hour cycle etc., for inflating and deflating selective bladder arrangements. The control panel 191 may alternatively or additionally comprise input means (not shown) for selecting specific times for inflating and deflating the selective bladder arrangements.

The primary sub-conduit 161 is disposed adjacent a first lateral side edge 102 of the platform 110 and extends along the length of the platform. A section of the primary sub-conduit 161 which extends adjacent the first side edge 102, extends within the distal end 141D of the lower tier 140^{L} of bladder elements 141 of the first primary bladder arrangement 140a. This section of the primary sub-conduit 161 is perforated to enable fluid to pass between the primary sub-conduit 161 and the lower tier of bladder elements 141 of the first primary bladder arrangement 140a. The perforated conduit section further minimises any blockages from developing which would otherwise prevent or impede a desired inflation and deflation of the first primary bladder arrangement 140a.

The secondary sub-conduit 162 is disposed adjacent a second lateral side edge 103 of the platform 110 and extends along the length of the platform. A section of the secondary sub-conduit 162 which extends adjacent the second side edge 103, extends within the distal end 151^{D} of the bladder elements 151 associated with the second secondary bladder arrangement 150b. This section of the secondary sub-conduit is similarly perforated to enable fluid to pass between the secondary sub-conduit 162 and the bladder elements 151 of the second secondary bladder arrangement 150b. The perforated conduit section similarly minimises any blockages from developing which would otherwise prevent or impede a desired inflation and deflation of the second secondary bladder arrangement 150b.

A distal end of the primary sub-conduit 161 is arranged to extend a first distance from the first side edge 102 and a distal end of the secondary sub-conduit 162 is arranged to extend a second distance from the second side edge 103. The first and second distances are such that the distal end of the primary sub-conduit 161 and the distal end of the secondary sub-conduit 162 can couple together to fluidly couple the first primary bladder arrangement 140a and the second secondary bladder arrangement 150b to form a first patient turning arrangement.

A proximal end of the primary sub-conduit 161 is fluidly couplable with the pump 180 and a proximal end of the secondary sub-conduit 162 comprises a closed or sealed end. In this respect, the first and second sub-conduits 161, 162 of the first conduit 160 are coupled together in a series or daisy-chain arrangement to inflate and deflate the bladder arrangements 140a, 150b of the first patient turning arrangement.

In a similar manner, the primary bladder arrangement 140 disposed at the second side of the central region 101, namely a second primary bladder arrangement 140b and the secondary bladder arrangement 150 disposed at the first side of the central region 101, namely a first secondary bladder arrangement 150a (as shown in FIG. 8) are fluidly coupled together via a second conduit 170. The second conduit 170 similarly comprises a primary and secondary sub-conduit 171, 172 (see FIG. 8) which are coupled together at a connector 173 (see FIG. 8), and the second conduit 170 is arranged to communicate a fluid between the pump 180 and the associated bladder arrangements 140b, 150a.

The primary sub-conduit 171 is disposed adjacent the second lateral side edge 103 of the platform 110 and extends along the length of the platform 110. A section of the primary sub-conduit 171 which extends adjacent the second side edge 103, extends within the distal end 141D of the lower tier 140^{L} of bladder elements 141 of the second primary bladder arrangement 140b. This section of the primary sub-conduit 171 is perforated to enable fluid to pass between the primary sub-conduit 171 and the second primary bladder arrangement 140b. The perforated conduit section further minimises any blockages from developing which would otherwise prevent or impede a desired inflation and deflation of the second primary bladder arrangement 140b.

The secondary sub-conduit 172 is disposed adjacent the first lateral side edge 102 of the platform 110 and extends along the length of the platform. A section of the secondary sub-conduit 172 which extends adjacent the first side edge 102, extends within the distal end 151^{D} of the bladder elements 151 associated with the first secondary bladder arrangement 150a (see FIG. 8). This section of the secondary sub-conduit is similarly perforated to enable fluid to pass between the secondary sub-conduit 172 and the first secondary bladder arrangement 150a. The perforated conduit section similarly minimises any blockages from developing which would otherwise prevent or impede a desired inflation and deflation of the first secondary bladder arrangement 150a.

A distal end of the primary sub-conduit 171 is arranged to extend a first distance from the second side edge 103 and a distal end of the secondary sub-conduit 172 is arranged to extend a second distance from the first side edge 102. The first and second distances are such that the distal end of the primary sub-conduit 171 and the distal end of the secondary sub-conduit 172 can couple together to fluidly couple the second primary bladder arrangement 140b and the first secondary bladder arrangement 150a to form a second patient turning arrangement.

A proximal end of the primary sub-conduit 171 is fluidly couplable with the pump 180 and a proximal end of the secondary sub-conduit 172 comprises a closed or sealed end. In this respect, the first and second sub-conduits 171, 172 of the second conduit 170 are coupled together in a series or daisy-chain arrangement to inflate and deflate the bladder arrangements of the second patient turning arrangement.

The spacing of the distal ends of the sub-conduits 161, 162, 171, 172 from the lateral side edges 102, 103 of the platform 110 is designed to prevent or minimise any incorrect fluid coupling between the primary and secondary bladder arrangements 140, 150 at each side of the central region 101. For example, a distal end of the first primary sub-conduit 161 is spaced a first distance from the first side edge 102, and the distal end of the second primary sub-conduit 171 is similarly spaced a first distance from the second side edge 103. This respective spacing is such that the distal ends cannot meet together to fluidly couple together and thus prevent an incorrect coupling of bladder arrangements 140, 150.

In a second fluid coupling embodiment, as illustrated in FIG. 8 of the drawings, the first primary bladder arrangement 140a and the second secondary bladder arrangement 150b are fluidly coupled together via a first and second sub-conduit 160 in a parallel configuration. In this respect, the first conduit 160 comprises a first branch 160′ which is coupled at a proximal end thereof to the pump 180, and at a distal end thereof to a T-piece connector 163. The primary and secondary sub-conduits 161, 162 of the first conduit 160 then extend from a respective connector portion of the T-piece connector 163 to communicate a fluid to and from the first primary and second secondary bladder arrangement 140a, 150b of the first patient turning arrangement. Specifically, the primary sub-conduit 161 extends adjacent a first lateral side edge 102 of the platform 110 and extends along the length of the platform 110. A section of the primary sub-conduit 161 which extends adjacent the first side edge 102, extends within the distal end 141D of the lower tier 140^{L} of bladder elements 141 of the first primary bladder arrangement 140a. The secondary sub-conduit 162 extends adjacent a second lateral side edge 103 of the platform 110 and extends along the length of the platform 110. A section of the secondary sub-conduit 162 which extends adjacent the second side edge 103, extends within the distal end 151^{D} of the bladder elements 151 of the second primary bladder arrangement 150b.

The section of the primary and secondary sub-conduits 161, 162 which extend within the respective arrangement of bladder elements 141, 151 is perforated to enable fluid to pass between the primary/secondary sub-conduit 161, 162 and the first/second primary/secondary bladder arrangement 140a, 150b, respectively. The perforated conduit section further minimises any blockages from developing which would otherwise prevent or impede a desired inflation and deflation of the first/second primary/secondary bladder arrangement 140a, 150b. A proximal end of the primary and secondary sub-conduit 161, 162 is fluidly coupled with a portion of the T-piece connector, and a distal end of the primary and secondary sub-conduit 161, 162 is closed.

Similarly, the second conduit 170 comprises a second branch 170′ which is coupled at a proximal end thereof to a pump 180, and at a distal end thereof to a T-piece connector 173. The primary and secondary sub-conduits 171, 172 of the second conduit 170 then extend from a respective connector portion of the T-piece connector 173 to communicate a fluid to and from the second primary and first secondary bladder arrangement 140b, 150a of the second patient turning arrangement. Specifically, the primary sub-conduit 171 extends adjacent a second lateral side edge 103 of the platform 110 and extends along the length of the platform 110. A section of the primary sub-conduit 171 which extends adjacent the second side edge 103, extends within the distal end 141D of the lower tier 140^{L} of bladder elements 141 of the second primary bladder arrangement 140b. The secondary sub-conduit 172 extends adjacent a first lateral side edge 102 of the platform 110 and extends along the length of the platform 110. A section of the secondary sub-conduit 172 which extends adjacent the first side edge 102, extends within the distal end 151^{D} of bladder elements 151 of the first secondary bladder arrangement 150a.

The section of the primary and secondary sub-conduits 171, 172 which extend within the respective arrangement of bladder elements 141, 151 is perforated to enable fluid to pass between the primary/secondary sub-conduit 171, 172 and the second/first primary/secondary bladder arrangement 140b, 150a, respectively. The perforated conduit section further minimises any blockages from developing which would otherwise prevent or impede a desired inflation and deflation of the second/first primary/secondary bladder arrangement 140b, 150a. A proximal end of the primary and secondary sub-conduit 171, 172 is fluidly coupled with a portion of the T-piece connector 173, and a distal end of the primary and secondary sub-conduit is closed.

In the first and second fluid coupling embodiments, the primary bladder arrangement 140a, 140b is configured to tilt the support slats 113 at the respective side of the platform 110 through an angular range of 20⁰-30⁰ when fully inflated, typically 25⁰, whereas the secondary bladder arrangement 150a, 150b is configured to tilt the support slats 113 at the respective side of the platform 110 through an angular range of 3⁰-10⁰ when fully inflated, typically 9⁰.

In use, the support platform 110 complete with the support slats 113, base slats 123, first and second primary and secondary bladder arrangements 140a, 140b, 150a, 150b, and the first and second conduits 160, 170, may be enclosed within a cover (not shown) which can be sealed to prevent any ingress of dirt or infectious material onto the platform 110. The cover (not shown) can be releasably sealed via a closure (not shown) and thus removed from the support platform 110 for cleaning. The support platform 110 may be initially arranged in a rolled, storage configuration and deployed by unrolling the platform upon the bed support frame SF such that the central region 101 of the platform 101 extends along a central longitudinal region of the bed support frame SF, with the support slats 113 and base slats 123 extending across the frame SF.

With the platform deployed upon the frame (and a mattress (not shown) disposed upon the support platform 110), an operator (not shown) subsequently fluidly couples the first and second conduits 160, 170 to the pump 180. The operator then selects the desired sequence for inflating and deflating the bladder arrangements 140, 150 associated with first and second patient turning arrangements. For example, the operator may select a 1-hour cycle via the control panel 191 on the controller 190. This cycle may initially cause the bladder arrangements 140a, 150b of the first patient turning arrangement to simultaneously inflate. As the first primary bladder arrangement 140a inflates, the slats 113 disposed at the first side (such as the right side) of the central region 101 will tilt relative to the base 120 about the central region 101, causing the patient to begin to turn to their left side. At the same time, the second secondary bladder arrangement 150b will inflate causing the slats 113 disposed at the second side (such as the left side) of the central region 101 to pivot relative to the base 120 about the central region 101. The first primary bladder arrangement 140a is configured to pivot the adjacent slats 130 through a greater angular range than the second secondary bladder arrangement 150b in order to turn a patient, however, the tilt provided by the slats 113 at the second side provides a cradling effect to prevent the patient sliding down the tilted side or migrating across the platform 110, and also prevent over-rotation of the patient, which may otherwise lead to the patient adopting a prone position or falling off the platform 110.

After 1-hour, the controller 190 may act to deflate the bladder arrangements 140a, 150b of the first patient turning arrangement which causes the plurality of slats 113 at the first side of the central region 101 to pivot downwardly toward the base 120, and thus lower the right side of the mattress (not shown) so that the patient (not shown) becomes lowered onto their back. At the same time, the second secondary bladder arrangement 150b will deflate causing the plurality of slats 113 at the second side to return to an unpivoted or flattened configuration.

The controller 190 may subsequently cause the bladder arrangements 140b, 150a of the second patient turning arrangement to inflate to cause the support slats 113 at the second side (left side for example) to pivot about the central region 101, thereby causing the left side of the mattress to lift and thus turn the patient onto their right side. At the same time, the first secondary bladder arrangement 150a will inflate causing the slats 113 disposed at the first side (such as the right side) of the central region 101 to pivot relative to the base 120 about the central region to cradle the patient during the turning process. Similarly, the second patient turning arrangement may remain in this position for 1-hour prior to the associated bladder arrangements 140b, 150a deflating and thus lowering the patient onto their back. The bladder arrangements 140, 150 associated with the apparatus 100 may then remain in a deflated state for a period of 1-hour, before the sequence recommences.

It will be appreciated that the invention as described above provides benefits for the healthcare of patients.

1. A patient turning apparatus comprising:
a reconfigurable support platform comprising:
a longitudinally extending central region, and a first lateral side disposed at a first side of the central region and a second lateral side disposed at a second side of the central region;
a first primary bladder arrangement and a first secondary bladder arrangement disposed at the first lateral side, and configured to impart a tilt to the first side of the platform about the central region;
a second primary bladder arrangement and a second secondary bladder arrangement disposed at the second lateral side, and configured to impart a tilt to the second side of the platform about the central region;
the first primary bladder arrangement and second secondary bladder arrangement forming a first patient turning arrangement, the second primary bladder arrangement and first secondary bladder arrangement forming a second patient turning arrangement; and
the support platform further comprising:
a first and second conduit along which a fluid is arranged to pass, the first conduit being fluidly coupled to the bladder arrangements of the first patient turning arrangement for simultaneously conveying fluid to and from the bladder arrangement of the first patient turning arrangement, the second conduit being fluidly coupled to the bladder arrangements of the second patient turning arrangement for simultaneously conveying fluid to and from the bladder arrangement of the second patient turning arrangement.

2. The apparatus according to claim 1, wherein the first primary bladder arrangement and first secondary bladder arrangement are disposed in a stacked configuration.

3. The apparatus according to claim 1, wherein the first primary bladder arrangement is disposed, in use, upon the first secondary bladder arrangement.

4. The apparatus according to claim 1, wherein second primary bladder arrangement and first secondary bladder arrangement are disposed in a stacked configuration.

5. The apparatus according to claim 1, wherein the second primary bladder arrangement is disposed, in use, upon the second secondary bladder arrangement.

6. The apparatus according to claim 1, wherein the primary bladder arrangement of each patient turning arrangement is configured to tilt the respective lateral side of the platform through an angular range greater than that of the secondary bladder arrangement of the same patient turning arrangement.

7. (canceled)

8. (canceled)

9. (canceled)

10. (canceled)

11. (canceled)

12. (canceled)

13. (canceled)

14. The apparatus according to claim 1, wherein the first conduit comprises a first primary sub-conduit which is fluidly coupled to the first primary bladder arrangement and a first secondary sub-conduit which is fluidly coupled to the second secondary bladder arrangement.

15. The apparatus according to claim 14, wherein a distal end of the first primary sub-conduit extends a first distance from a first lateral side edge of the platform and a distal end of the first secondary sub-conduit extends a second distance from a second lateral side edge of the platform, the first and second distances permitting a fluid coupling of the distal end of the first primary sub-conduit with the distal end of the first secondary sub-conduit.

16. The apparatus according to claim 14, wherein a section of the first primary sub-conduit and first secondary sub-conduit comprises a plurality of perforations disposed along a length thereof for fluidly coupling with the first primary bladder and second secondary bladder, respectively.

17. The apparatus according to claim 1, wherein the second conduit comprises a second primary sub-conduit which is fluidly coupled to the second primary bladder arrangement and a second secondary sub-conduit which is fluidly coupled to the first secondary bladder arrangement.

18. The apparatus according to claim 17, wherein a distal end of the second primary sub-conduit extends a first distance from a second lateral side edge of the platform and a distal end of the second secondary sub-conduit extends a second distance from a first lateral side edge of the platform, the first and second distances permitting a fluid coupling of the distal end of the second primary sub-conduit with the distal end of the second secondary sub-conduits.

19. The apparatus according to claim 17, wherein a section of the second primary and second secondary sub-conduits comprises a plurality of perforations disposed along a length thereof for fluidly coupling with the second primary bladder and second secondary bladder, respectively.

20. (canceled)

21. (canceled)

22. (canceled)

23. (canceled)

24. (canceled)

25. (canceled)

26. The apparatus according to claim 1, wherein each bladder arrangement of the first and second patient turning arrangements comprises a plurality of interconnected bladder elements, each element being detachably coupled at a proximal end thereof to the central region.

27. The apparatus according to claim 26, wherein the first primary bladder arrangement and second primary bladder arrangement separately comprise a two-tier arrangement of bladder elements with one tier being disposed above the other tier.

28. The apparatus according to claim 26, wherein the first secondary bladder arrangement and second secondary bladder arrangement comprises a single tier of bladder elements.

29. (canceled)

30. The apparatus according to claim 1, wherein the first primary bladder arrangement and first secondary bladder arrangement are welded together to prevent the first primary bladder arrangement and first secondary bladder arrangement from slipping relative to each other.

31. The apparatus according to claim 26, wherein the bladder elements of the first primary bladder arrangement and first secondary bladder arrangement are welded together.

32. The apparatus according to claim 1, wherein the second primary bladder arrangement and second secondary bladder arrangement are welded together to prevent the second primary bladder arrangement and second secondary bladder arrangement from slipping relative to each other.

33. The apparatus according to claim 26, wherein the bladder elements of the second primary bladder arrangement and second secondary bladder arrangement are welded together.
